(19) United States
(12) Patent Application Publication
(10) Pub. No.: US 2006/0200824 A1
(43) Pub. Date: Sep. 7, 2006

(54) Method for automatically associating contexts with a computing job

(75) Inventors: Cynthia A. Crane, Redmond, WA (US); Conor P. Morrison, Seattle, WA (US); Sivaprasad V. Padisetty, Redmond, WA (US); Darren J. Fisher, Sammamish, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Microsoft Corporation, Redmond, WA (US)

(21) Appl. No.: 11/073,166

(22) Filed: Mar. 4, 2005

(51) Int. Cl. G06F 9/46

(52) U.S. Cl. 718/100

(57) ABSTRACT

A mechanism is provided to automatically associate a data structure, e.g., a mix, containing one or more contexts with a computing job, wherein a context specifying specific operating conditions or permutations of a computing job. A mix can be associated to a computing job prior to and/or during the execution of the computing job. The computing job can then be executed in each context of the mix. Preferably, one or more constraints can be associated with the computing job prior to and/or during the execution of the computing job. Any context in a mix applied to the computing job that conflicts with a constraint of the computing job will be disassociated with the computing job.

### FIELD OF THE INVENTION

The present invention relates to computer software and, more particularly, to associating computing jobs with various contexts.

### BACKGROUND OF THE INVENTION

A computing job may be executed in different sets of operating conditions. A set of operating conditions specifies a context in which the computing job is executed. For example, a computing job may be a test case designed to test the functionality of a software product. The test case may be run in varying operating conditions such as different operating systems, data processors, and languages. For instance, a test case for a software product may be run on a Microsoft® Windows® XP operating system on an Intel® Pentium® data processor, or on a UNIX® operating system on a Sun Microsystems™ UltraSPARC data processor. Each set of the operating conditions constitutes a context for the test case.

Normally, for each permutation in operating conditions, i.e., a context, an individual copy of a computing job with the context has to be maintained. When the contexts are many and/or the computing job is large or complex, it becomes time-consuming and error-prone to maintain multiple copies of the computing job that are identical but for the contexts. For example, when one of the steps in the computing job needs to be updated, each copy of the computing job has to be updated individually. Therefore, there exists a need to maintain only one copy of a computing job, with the contexts stored separately so they can be applied to the computing job according to individual user requirements. For example, multiple contexts can be stored together in a data structure, e.g., called a “mix.” A mix is a separate entity from the computing job itself. For instance, a mix may include a first context of Intel® x86-based, Microsoft® Windows® XP Professional in the German language, a second context of Intel® x86-based, Microsoft Windows® Server™ 2003 in the English language, and a third context of Motorola® PowerPC®-based, Windows® NT™ in the English language. A computing job may be executed in each context in the mix.

However, at times, one or more contexts in an existing mix, when applied to a computing job, may conflict with one or more constraints associated with the computing job. For example, a context in a mix may specify that one of the operating system languages in which a test case can run, e.g., is Japanese. However, some test cases cannot run on an operating system whose language is Japanese. Thus, there exists a conflict between the context in the mix and a constraint of these test cases. In order to satisfy each constraint of a test case, mixes need to be custom tailored to the constraints of the test case to which they are applied. It thus becomes necessary to maintain numerous copies of similar mixes in order to address different constraints of different test cases. Such maintenance requires extensive computing resources. Therefore, there exists a need to resolve any conflicts between a context in a mix and one or more constraints of a computing job, while maintaining only one copy of a mix.

In summary, there exists a need to expand a computing job to cover multiple contexts of the computing job, while maintaining only one copy of the computing job. There also exists a need to resolve conflicts caused by differences between a context in a mix and one or more constraints of a computing job using the mix, while maintaining only one copy of the mix.

### SUMMARY OF THE INVENTION

The invention addresses the above-identified needs by providing a computer-implemented method, computer-readable medium, and a computing system for automatically associating a computing job with one or more contexts, prior to and/or during the execution of the computing job. Preferably, any context that conflicts with one or more constraints of the computing job is identified and disassociated with the computing job.

One aspect of the invention builds a data structure containing one or more contexts. The data structure is called a “mix,” for example. Preferably, a mix is associated with a plurality of parameters that specify various operating conditions for a computing job. Each of the parameters has one or more values. For example, the parameters can specify the operating system, the data processor, and the operating system language of a machine that a computing job can run on. Preferably, a mix is also associated with information such as a combinatory algorithm that specifies how to combine the parameters to generate one or more contexts. A mix may also be associated with one or more rules that prohibit specific combinations of the parameters. Information associated with a mix can be used to automatically generate one or more contexts for the mix.

Another aspect of the invention associates a mix with a computing job. One or more mixes can be associated with a computing job prior to and/or during the execution of the computing job. The computing job may thus be executed in each of the associated contexts.

In accordance with yet another aspect of the invention, one or more constraints can be associated with a computing job prior to and/or during the execution of the computing job. If a context in a mix associated with the computing job conflicts with a constraint of the computing job, the context is identified and disassociated from the computing job.

In summary, the invention automatically applies one or more mixes containing one or more contexts to a computing job, prior to and/or during the execution of the computing job. The invention thus provides a mechanism for expanding a computing job to cover multiple permutations of the computing job, while only maintaining one copy of the computing job. This mechanism is particularly useful for large or complex computing jobs that need to be performed multiple times in different contexts.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram illustrating an exemplary mix containing multiple contexts;

FIG. 2 is a block diagram illustrating an exemplary application of a mix to a test case prior to the execution of the test case;

FIG. 3 is a block diagram illustrating an exemplary application of a mix to a test case, such as the test case illustrated in FIG. 2, during the execution of the test case; and

FIG. 4 is a flow diagram illustrating an exemplary process for applying one or more mixes to a test case, prior to and/or during the execution of the test case.

### DETAILED DESCRIPTION OF THE PREFERRED EMBODIMENT

Embodiments of the invention apply a data structure containing one or more contexts to a computing job, such as a test case, to associate the computing job with different contexts. The data structure may be called a mix. The addition of a mix to a computing job can occur prior to and/or during the execution of the computing job. If a context in the mix conflicts with one or more constraints of the computing job, the context is identified and disassociated from the computing job.

The invention will primarily be described in the context of applying one or more mixes to a test case prior to and/or during the execution of the test case. However, those skilled in the relevant art and others will appreciate that the invention is also applicable to any computing job that can be executed with various permutations in operating environments.

The following text first describes what a mix is and exemplary ways of constructing a mix. Then a computer-implemented method is described. In essence, the method associates a test case with one or more mixes and constraints prior to and/or during the execution of the test case. Preferably, the method also identifies any context in a mix that conflicts with one or more constraints associated with the test case. The method then disassociates such a context from the test case. The illustrative examples provided herein are not intended to be exhaustive or to limit the invention to the precise forms disclosed. Similarly, any steps described herein may be interchangeable with other steps, or combinations of steps, in order to achieve the same result.

The Mix Data Structure

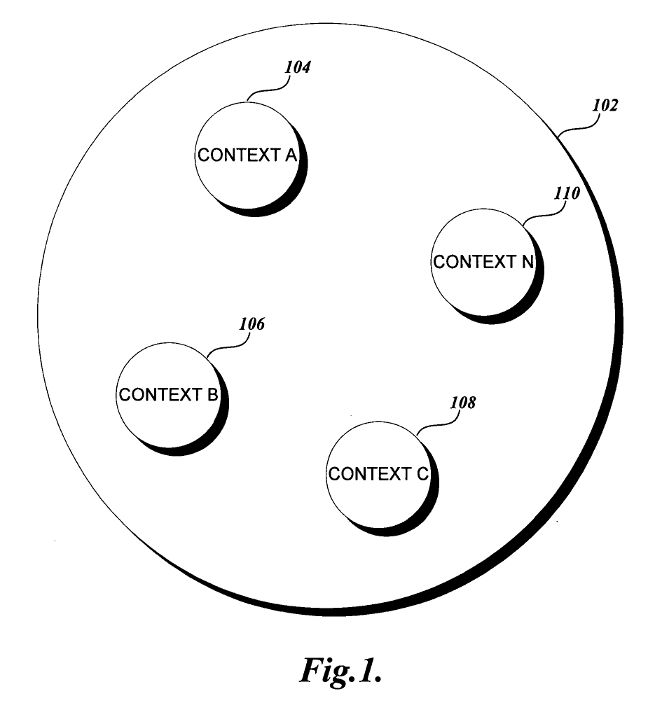

In an exemplary embodiment of the invention, a data structure called a mix is used to include one or more contexts. A context is a set of operating conditions that can be applied to a test case. When associated with a mix, a test case can be executed in the one or more contexts included in the mix. Scheduling a test case to run creates one instance of the test case for each valid context within the mix. FIG. 1 is a block diagram illustrating a mix 102 that contains multiple contexts, such as context A 104, context B 106, context C 108, and context N 110. For example, the mix 102 may include a first context of Intel® x86-based, Microsoft® Windows® XP Professional in the German language, a second context of Intel® x86-based, Microsoft® Windows® Server™ 2003 in the English language, and a third context of Intel® Itanium®-based, Windows® Server™ 2003 in the English language. A test case associated with the mix 102 can be potentially executed in each of the three contexts.

In exemplary embodiments of the invention, a mix is associated with a set of parameters, each of which may have one or more values. A parameter can be a dimension. A dimension is generally a pre-defined attribute or any necessary hardware or software peripherals associated with a machine or computer program. For example, a dimension can specify the data processor, the operating system, or the language attribute of a machine.

In exemplary embodiments of the invention, the value of a dimension may be passed to a test case to change the way a test case behaves. An example of such a dimension would be “STRING TYPE: ANSI, Unicode,” which means that the value of the STRING TYPE dimension can be either ANSI or Unicode. When ANSI is passed to a test case as the value of the STRING TYPE dimension, the test case will send ANSI characters as input to the application it is testing. When Unicode is passed to a test case as the value of the STRING TYPE dimension, the test case will send Unicode characters to the application it is testing.

A dimension can also be a constraint, whose value(s) are attached to a test case to specify a proper operating condition required to run the test case. An exemplary constraint would be “OPERATING SYSTEM: Windows® 98, Windows® 2000, Windows® XP.” When this exemplary constraint is attached to a test case, the test case should only be run on one of the three operating systems. In exemplary embodiments of the invention, constraints can be part of a mix or a test case definition, or be applied to a test case at runtime (hereinafter “runtime constraint”). When a constraint in a context of a mix conflicts with a constraint associated with a test case, the context in the mix is regarded as an invalid context for the test case and is disassociated from the test case.

A parameter associated with a mix can also be a custom parameter that is supplied by a user. A custom parameter specifies attributes that are not pre-defined by a system. Such attributes include valid file names, time of day for executing a test case, etc. A user can associate as many custom parameters to a mix as the user wishes.

A mix may be further associated with a combinatory algorithm, which dictates how to create multiple contexts using the set of parameters associated with a mix. An exemplary combinatory algorithm would be a full combinatory algorithm, which generates all valid combinations of parameter values associated with a mix. Other combinatory algorithms include “N-Wise” and “Random” combinatory algorithms. The “N-Wise” combinatory algorithm generates unique combinations of parameters associated with a mix; each combination includes N parameter values. The value of “N” controls the number of parameter values in a combination. For example, a value of “2” would ensure every unique pair of parameter values is produced; a value of “3” would ensure every unique triple of parameter values is produced; and so forth. Preferably, each parameter value may be associated with a weight property, which indicates the relative importance of the parameter value compared to other parameter values and hence affects how likely the parameter value will be selected by the combinatory algorithm associated with the mix.

Preferably, a mix may also be associated with a set of rules that are used to identify combinations of parameters that are not permissible. An exemplary rule is “Unicode not valid with Windows® 98.” This exemplary rule indicates that if the application to be tested is running on Windows® 98, then the application cannot accept Unicode input. This exemplary rule would not allow the mix to include the context “Unicode, Windows® 98”.

In embodiments of the invention, a mix can be a global mix or a custom mix. A global mix can be applied to all test cases. On the other hand, a custom mix is a user-defined collection of contexts based on information associated with a mix and is applied to an individual test case. The information associated with the mix can be the above-discussed parameters, combinatory algorithm, and/or rules. In some embodiments, a user can also utilize a default mix for a specific test case.

In some embodiments of the invention, a global mix may be a simple mix or an advanced mix. A simple mix is a collection of contexts that are manually created by a user according to information associated with a mix. An advanced mix, on the other hand, contains a collection of automatically generated contexts, using information associated with the mix. An exemplary embodiment of the invention feeds information associated with a mix to an automated contexts generation mechanism, which then produces multiple contexts for the mix. The resultant mix is called an advanced mix. An exemplary implementation of an automated contexts generation mechanism is described in detail in U.S. Patent Application No. 2004/0255275 titled METHOD AND SYSTEM FOR GENERATING AN EFFICIENT TEST SUITE FROM A DOMAIN DESCRIPTION WITH GIVEN CONSTRAINTS” and filed on Jun. 11, 2003 (hereinafter “Test Suite Generation”), which is incorporated herein by reference. Specifically, the Test Suite Generation patent application describes a test case generation mechanism that takes a set of parameters and their corresponding values, preferably a set of constraints that prohibit specific parameters and values, and preferably information as to what N-Wise combinations of the parameters should be produced. The test cases generation mechanism then outputs a suite of test cases that are compliant to the parameters, the constraints, and/or the specified combinatory algorithm. As appreciated by those ordinarily skilled in the art, the test cases generation mechanism disclosed in the Test Suite Generation patent application can be adapted as an automated context generation mechanism for generating multiple contexts that comply with the parameters, rules, and/or combinatory algorithm associated with a mix.

Method for Applying One or More Mixes to a Test Case

As noted above, a mix can provide a test case the ability to run in one or more contexts. In exemplary embodiments of the invention, a mix can be added to a test case prior to and/or during the execution of the test case. The test case thus is associated with the one or more contexts within each mix. Preferably, the test case is associated with one or more constraints prior to and/or during the execution of the test case. If any of the contexts conflict with a constraint associated with the test case, such a context is disassociated from the test case.

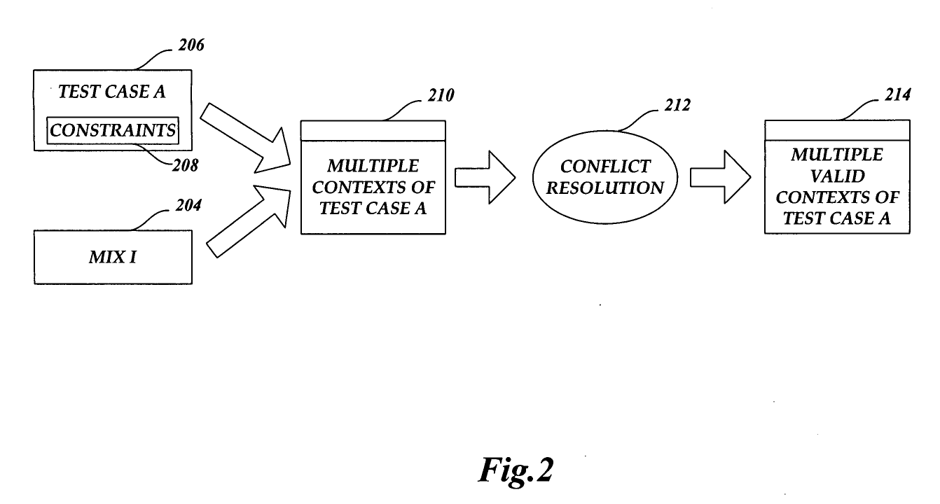

FIG. 2 is a block diagram illustrating an exemplary application of a mix I 204 to a test case A 206 prior to the execution of the test case A 206. The addition of mix I 204 to the test case A 206 results in multiple contexts 210 becoming associated with the test case A 206. As shown in FIG. 2, the test case A 206 may have one or more constraints 208. The multiple contexts 210 of test case A 206 go through a conflict resolution procedure 212, which identifies and removes any invalid context that conflicts with one or more constraints 208 of the test case A 206. The conflict resolution procedure 212 thus identifies one or more valid contexts 214 for executing the test case A 206.

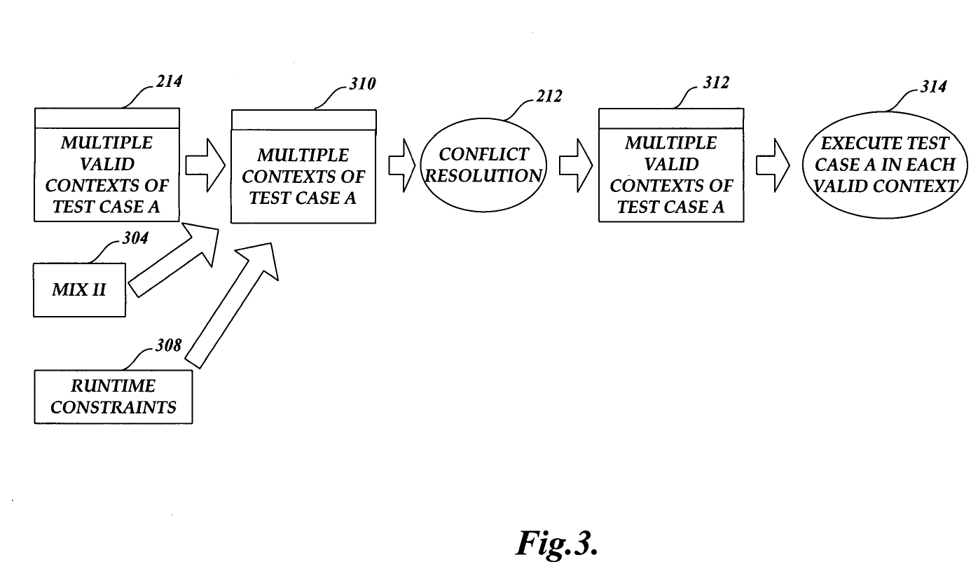

Exemplary embodiments of the invention may also apply one or more mixes to a test case during the execution of the test case. FIG. 3 is a block diagram illustrating an exemplary application of a mix II 304 to the test case A 206 illustrated in FIG. 1. The test case A 206 has already been associated with the multiple valid contexts 214, as a result of the exemplary application of the mix I 204 illustrated in FIG. 1. After being applied with the mix II 304, the test case A 206 is now associated with multiple contexts 310, which includes the multiple valid contexts 214 and contexts supplied by the mix II 304. Some embodiments of the invention also associate additional constraints, e.g., runtime constraints 308, to the test case A 206. The resultant multiple contexts 310 of the test case A 206 then go through the conflict resolution procedure 212. The conflict resolution procedure 212 eliminates any context in the mix II 304 that conflicts with the multiple valid contexts 214 of the test case A 206. The conflict resolution procedure 212 also eliminates any context in the mix II 304 that conflicts with any constraint of the test case A 206, such as the constraints 208 (FIG. 2) and the runtime constraints 308. The conflict resolution procedure 212 thus identifies multiple valid contexts 312 for the test case A 206. A process 314 then may be initiated to execute the test case A 206 in each of the multiple valid contexts 312.

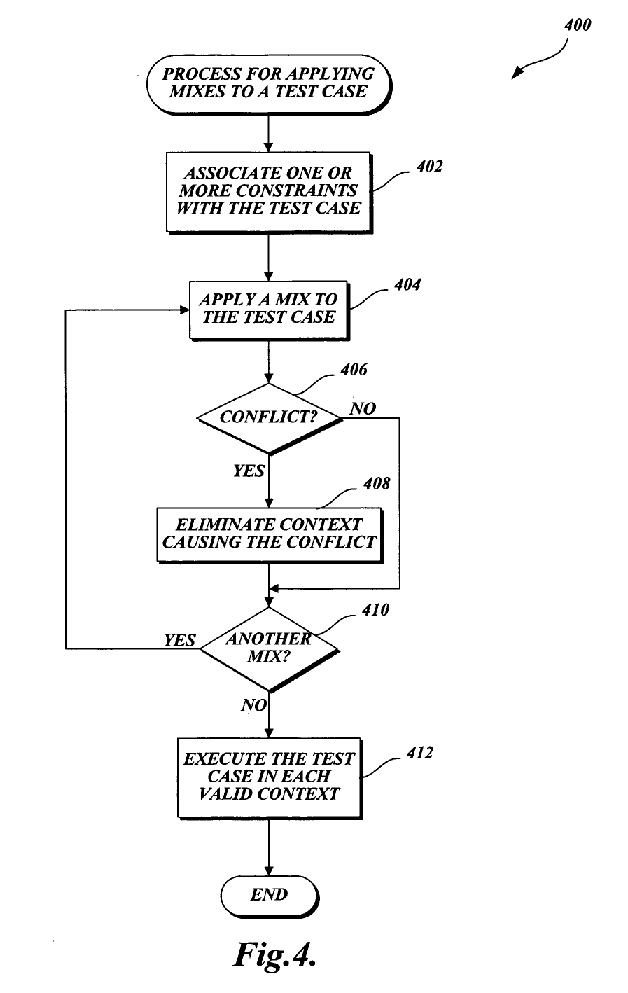

FIG. 4 is a flow diagram illustrating an exemplary process 400 that applies one or more mixes to a test case. The process 400 may be used for applying one or more mixes to a test case prior to the execution of the test case, such as the exemplary application of the mix I 204 to the test case A 206 illustrated in FIG. 2. The process 400 may also be used for applying one or more mixes to a test case during the execution of the test case, such as the exemplary application of a mix II 304 to the test case A 206 illustrated in FIG. 3.

Exemplary embodiments of the invention may associate one or more constraints with the test case. See block 402. As noted above when describing an exemplary mix data structure, constraints identify operating conditions under which a test case can be executed. For example, constraints can specify the necessary configurations of a machine that the test case can run on. The process 400 then applies a mix to the test case. See block 404. As noted above, a mix includes one or more contexts, each of which may contain one or more constraints. The process 400 then proceeds to check whether constraints in any of the contexts in the mix conflict with the constraints associated with the test case. See decision block 406. A conflict arises, for example, when a context in the mix specifies the machine operating system to be Microsoft® Windows® XP, when a constraint of the test case specifies that the test case needs to be run on a machine with the operating system Microsoft® Windows® 98. If the answer to decision block 406 is YES, the process 400 proceeds to disassociate any context in the mix that causes a conflict from the test case. See block 408. After executing the block 408, or if the answer to decision block 406 is NO, the process 400 proceeds to check if an additional mix needs to be applied to the test case. See decision block 410. If the answer to decision block 410 is YES, the process 400 loops back to block 404 to apply the additional mix to the test case. If the answer to decision block 410 is NO, the process 400 executes the test case in each of the valid contexts associated with the test case. See block 412. The process 400 then terminates.

Embodiments of the invention can be implemented in a single computer system or a distributed computing system. At a minimum, the computing system comprises a data processor for executing computer-executable instructions that build and apply one or more mixes to a computing job, prior to and/or during the execution of the computing job.

While the preferred embodiments of the invention have been illustrated and described, it will be appreciated that various changes can be made therein without departing from the spirit and scope of the invention.

The embodiments of the invention in which an exclusive property or privilege is claimed are defined as follows:

1. A computer-implemented method for automatically associating a computing job with one or more contexts, comprising:
building a data structure (“mix”) containing one or more contexts;
associating the mix with a computing job; and
executing the computing job in each context of the mix.

2. The computer-implemented method of claim 1, further comprising associating one or more constraints with the computing job.

3. The computer-implemented method of claim 2, further comprising eliminating any context in the mix that conflicts with a constraint of the computing job.

4. The computer-implemented method of claim 1, wherein the mix is associated with one or more parameters that are used to define a context of the mix, wherein each parameter has one or more parameter values.

5. The computer-implemented method of claim 4, wherein the mix is further associated with information that specifies how to combine parameters to form the one or more contexts for the mix.

6. The computer-implemented method of claim 5, wherein the mix is further associated with one or more rules that prohibit one or more parameter combinations.

7. The computer-implemented method of claim 1, wherein building a mix containing one or more contexts further includes using information associated with a mix to automatically generate the one or more contexts for the mix.

8. The computer-implemented method of claim 1, wherein associating the mix with the computing job occurs prior to execution of the computing job.

9. The computer-implemented method of claim 1, wherein associating the mix with the computing job occurs during the execution of the computing job.

10. A computer-readable medium having computer-executable instructions thereon for implementing a method for automatically associating a computing job with one or more contexts, comprising:
building a data structure (“mix”) containing one or more contexts;
associating the mix with a computing job; and
executing the computing job in each context of the mix.

11. The computer-readable medium of claim 10, further comprising associating one or more constraints with the computing job.

12. The computer-readable medium of claim 11, further comprising eliminating any context in the mix that conflicts with a constraint of the computing job.

13. The computer-readable medium of claim 10, wherein the mix is associated with one or more parameters that are used to define a context of the mix, wherein each parameter has one or more parameter values.

14. The computer-readable medium of claim 13, wherein the mix is further associated with information that specifies how to combine parameters to form the one or more contexts for the mix.

15. The computer-readable medium of claim 10, wherein building a mix containing one or more contexts further includes using information associated with a mix to automatically generate the one or more contexts for the mix.

16. The computer-readable medium of claim 10, wherein associating the mix with the computing job occurs prior to execution of the computing job.

17. The computer-readable medium of claim 10, wherein associating the mix with the computing job occurs during the execution of the computing job.

18. A computer system that automatically associates a computing job with one or more contexts comprising a data processor, wherein the data processor is configured with computer-implemented instructions for:
building a data structure (“mix”) containing one or more contexts;
associating the mix with a computing job; and
executing the computing job in each context of the mix.

19. The computer system of claim 18, wherein the data processor is further configured with computer-implemented instructions for associating one or more constraints with the computing job.

20. The computer system of claim 19, wherein the data processor is further configured with computer-implemented instructions for eliminating any context in the mix that conflicts with a constraint of the computing job.
